(19) United States
(12) Patent Application Publication
(10) Pub. No.: US 2003/0213180 A1
(43) Pub. Date: Nov. 20, 2003

(54) Waterproof device for a rolling barrier

(76) Inventor: Shiro Ueda, Komaki-Shi (JP)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/152,292

(22) Filed: May 20, 2002

(51) Int. Cl. E06B 7/16

(52) U.S. Cl. 49/489.1

(57) ABSTRACT

A waterproof device arranged on an upper doorframe for a rolling barrier of the door consists of a fixing member securely attached on the upper doorframe and a rubber gasket member pivotally connected with the fixing member. The fixing member particularly has a cylindrical groove. The rubber gasket member is integrally formed with a cylindrical connecting portion pivotally fitted in the cylindrical groove and a tongue-like extension portion extended through an opening of the cylindrical groove. The length of the tongue-like extension portion is larger than a distance between the fixing member and the rolling barrier. When the rolling barrier is drawn downward, a retaining block formed on the rolling barrier presses tightly against an inner side surface of an outer end of the extension portion, therefore the upper doorframe of the rolling barrier is prevented from being penetrated by rain water.

### BACKGROUND OF THE INVENTION

1. Field of the Invention

The present invention relates to a waterproof device arranged on an upper doorframe of a rolling barrier of a door to prevent water leaking through the barrier into a premises.

2. Description of Related Art

Rolling barriers are widely used at many places, such as a garage or a storehouse. The rolling barrier is arranged in cooperation with a doorframe having two opposite sides thereof being sealed with gasket sheets. Whereby the rolling barrier normally screens the rain without any water leaking through the opposite sides.

However, an upper doorframe of the conventional rolling barrier normally does not have any waterproof device provided therewith, so there is still a shortcoming that the upper doorframe of the conventional rolling barrier is not sealed against rainwater.

Therefore, it is an objective of the invention to provide a waterproof device arranged on the upper doorframe of the rolling barrier to mitigate and/or obviate the aforementioned problems.

### SUMMARY OF THE INVENTION

The main object of the present invention is to provide a waterproof device particularly arranged on an upper doorframe for a rolling barrier of a door. The waterproof device consists of a fixing member securely attached on an inner side of a lower end of the upper doorframe and a rubber gasket member pivotally connected with a lower end of the fixing member. The fixing member has a cylindrical groove defined at a lower end thereof. The gasket member is integrally formed with a cylindrical connecting portion pivotally retained in the cylindrical groove of the fixing member and a tongue-like extension portion extended outward through an opening of the cylindrical groove. The diameter of the cylindrical connecting portion is smaller than that of the cylindrical groove and larger than the width of the opening of the cylindrical groove. The length of the extension portion is larger than a distance between the fixing member and the rolling barrier. When the rolling barrier is drawn downward to a completely closed situation, a retaining block formed on the rolling barrier presses tightly against an inner side of an outer end of the extension portion, therefore an upper doorframe is sealed against penetration of rain water.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a waterproof device for a rolling barrier of a door in accordance with the invention;

FIG. 2 is a side view of the waterproof device in accordance with the invention, showing the rolling barrier being drawn downward to a completely closed situation;

FIG. 3 is a side view of the waterproof device in accordance with the invention, showing the rolling barrier being retracted upward; and

FIG. 4 is a schematic plan view of the waterproof device in accordance with the invention, showing the waterproof device being arranged on an upper doorframe of the door in cooperation with the rolling barrier.

### DETAILED DESCRIPTION OF THE PREFERRED EMBODIMENT

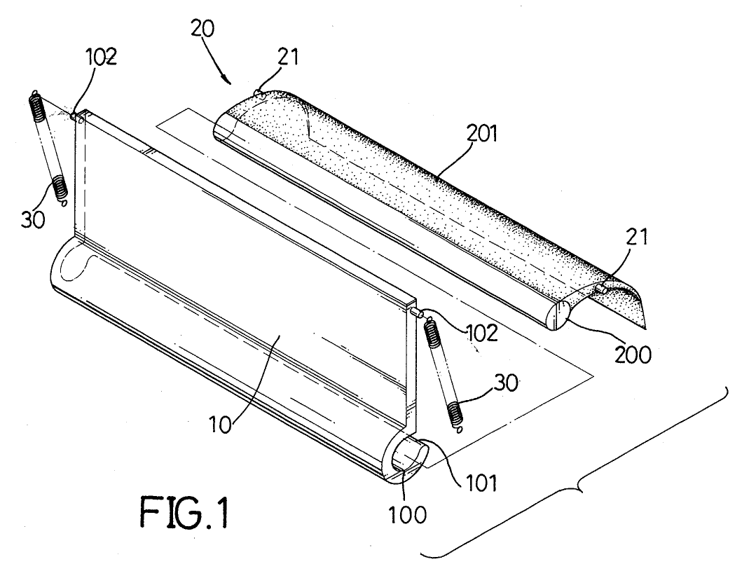

As shown in FIG. 1, the present invention relates to a waterproof device arranged on an upper doorframe for a rolling barrier of a door. The waterproof device consists of a fixing member (10) securely attached on an inner side of a lower end of an upper doorframe (not shown in FIG. 1), and a rubber gasket member (20) pivotally connected at the lower end of the fixing member (10).

The fixing member (10) is particular defined with a cylindrical groove (100) at a lower end thereof. An opening (101) of the cylinder groove (100) is defined at an upper outer side of the cylindrical groove (100), and defined with a predetermined width smaller than the diameter of the cylinder groove (100).

The gasket member (20) is integrally formed with a cylindrical connecting portion (200) pivotally retained in the cylindrical groove (100) of the fixing member (10), and a tongue-like extension portion (201) extending outward through the opening (101) of the fixing member (10) and tapering smaller from the connecting portion (200) to an outer end thereof. The length of the extension portion (201) is larger than the distance between the fixing member (10) and the rolling barrier. The cylindrical connecting portion (20) is also optionally enclosed with a metal sleeve, which is pivotally fitted in the cylindrical groove (100).

Two elastic members (30) are symmetrically provided at opposite ends of the waterproof device between the fixing member (10) and the gasket member (20). The fixing member (10) has two posts (102) respectively formed at opposite ends near an upper edge thereof. The extension portion (201) of the gasket member (20) is integrally formed with two stubs (21) at two predetermined positions of opposite ends thereof. Whereby the elastic members (30) have first ends thereof respectively connecting with the posts (102) of the fixing member (10) and second ends thereof respectively connecting with the stubs (21) of the extension portion (201).

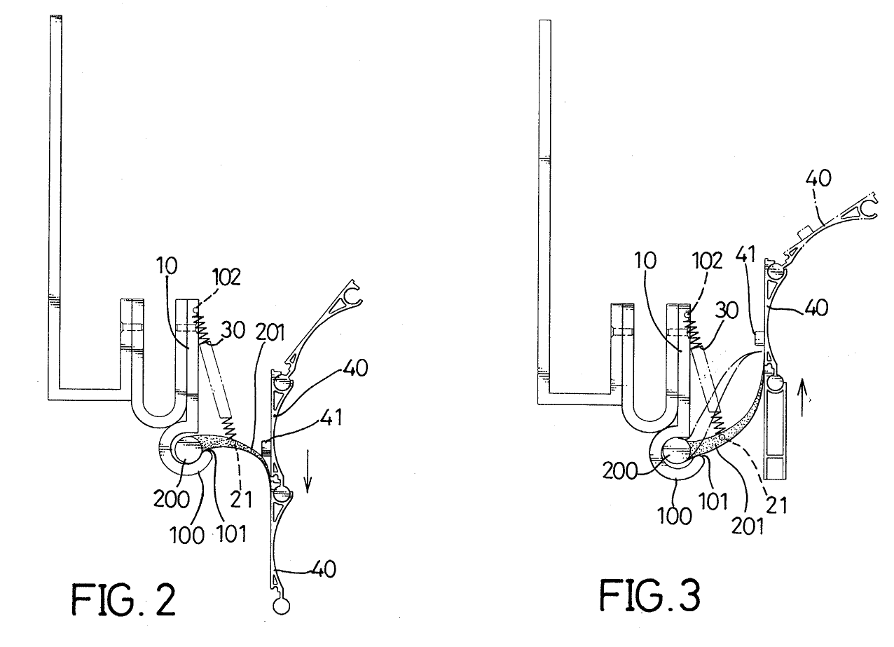

As shown in FIGS. 2 to 4, the waterproof device of the invention is arranged on an upper doorframe of a door where a rolling barrier (4) is installed. The rolling barrier (4) consists of a plurality of transversal panels (40).

With reference to FIG. 2, when the rolling barrier (4) is drawn downward to a completely closed situation, a retaining block (41) formed on the transversal panel (40) presses tightly against an inner side surface of the extension portion (201). Because the length of the extension portion (201) is larger than the distance between the fixing member (10) and the transversal panel (40), and the extension portion (201) is forced upwardly by the elastic members (30), the retaining block (41) abuts against an inner side surface of the outer end of the extension portion (201) tightly, therefore an upper doorframe of the rolling barrier (4) is prevented from being penetrated by rain water.

With reference to FIG. 3, when the rolling barrier (4) is retracted, the outer end of the extension portion (201) of the gasket member (20) is pressed upward by friction force between the transversal panels (40) and the outer end of the extension portion (201), and is retracted by the elastic force of the elastic members (30) to a position in which the outer end of the extension portion (201) is disposed slightly apart from the transversal panels (40). Therefore the rolling barrier (4) can be retracted easily without any resistance.

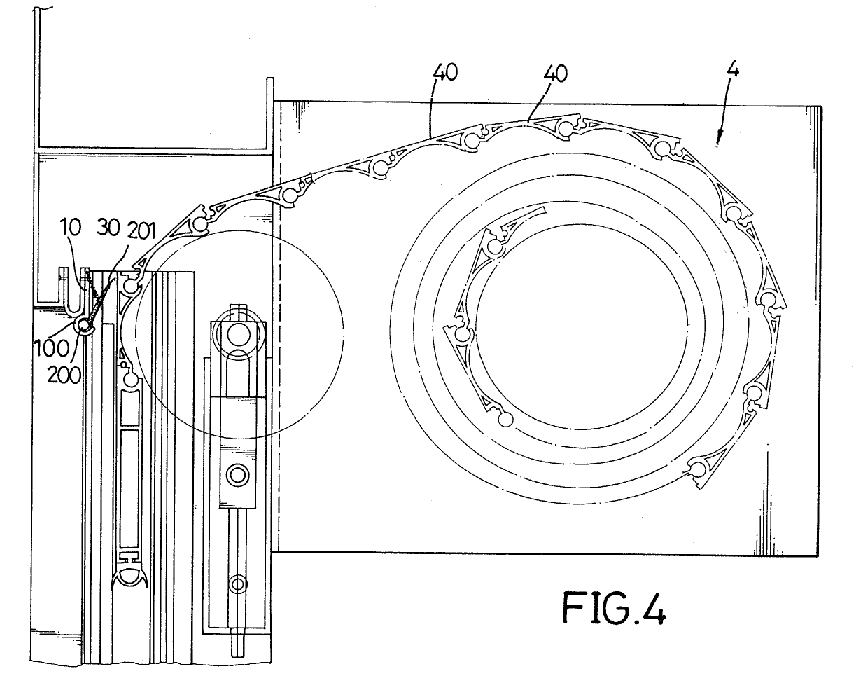

FIG. 4 shows the rolling barrier (4) fully retracted whereby the waterproof device sealingly abuts the upper doorframe of the door.

The waterproof device of the invention still has another advantage which is that because the extension portion (201) has a length larger than the distance between the fixing member (10) and the rolling barrier (4), and also because of the flexibility of the extension portion (201), the extension portion (201) must be in complete contact with the retaining block (41) of the rolling barrier (4), even though the doorframe is not completely parallel to the rolling barrier (4), so that the waterproof characteristic of the invention is ensured.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A waterproof device for a rolling barrier of a door, the waterproof device comprises
a fixing member (10), which is securely attached on an inner side of a lower end of an upper doorframe of the door, and defined with a cylindrical groove (100) at the lower end thereof, and an opening (101) at an upper outer side of the cylindrical groove (100), a diameter of the cylindrical groove (100) being larger than a width of the opening (101);
a resilient gasket member (20), which is integrally formed with a cylindrical connecting portion (200) pivotally fitted in the cylindrical groove (100), and a tongue-like extension portion (201) extending outward through the opening (101) of the cylindrical groove (100) and thinned gradually from the connecting portion (200) to an outer end thereof, a diameter of the cylindrical connecting portion (200) being larger than the width of the opening (101) and smaller than the diameter of the cylindrical groove (100), the extension portion (201) having a length larger than a distance between the fixing member (10) and the rolling barrier;
whereby when the rolling barrier is drawn downward to a completely closed situation, a retaining block formed on the rolling barrier abuts against an inner side surface of the outer end of the extension portion (201) of the resilient gasket member (20) so as to prevent the upper doorframe of the rolling barrier from being penetrated by water.

2. The waterproof device as claimed in claim 1, wherein two elastic members (30) are symmetrically provided at opposite ends of the waterproof device, and respectively have two first ends thereof connecting with the opposite ends of the fixing member (10) and two second ends thereof connecting with the extension portion (201) of the resilient gasket member (20).

3. The waterproof device as claimed in claim 2, wherein the fixing member (10) has two posts (102) respectively formed at opposite ends near an upper edge thereof, the extension portion (201) of the gasket member (20) is integrally formed with two stubs (21) at two opposite ends thereof, whereby the elastic members (30) have the first ends thereof respectively connecting with the posts (102) of the fixing member (10) and the second ends thereof respectively connecting with the stubs (21) of the extension portion (201).

4. The waterproof device as claimed in claim 1, wherein the stubs (21) are symmetrically formed at predetermined positions of the opposite ends of the extension portion (201).

5. The waterproof device as claimed in claim 1, wherein the cylindrical connecting portion (200) of the gasket member (20) is enclosed with a metal sleeve, which is pivotally fitted in the cylindrical groove (100).

6. The waterproof device as claimed in claim 1, wherein the resilient gasket member (20) is made of rubber.
